(19) United States
(12) Patent Application Publication
(10) Pub. No.: US 2014/0157172 A1
(43) Pub. Date: Jun. 5, 2014

(54) GEOGRAPHIC LAYOUT OF PETROLEUM DRILLING DATA AND METHODS FOR PROCESSING DATA

(71) Applicant: Drillmap, Austin, TX (US)

(72) Inventors: Aaron Ross Peery, Austin, TX (US); Robert Richards, Austin, TX (US)

(73) Assignee: Drillmap, Austin, TX (US)

(21) Appl. No.: 13/787,372

(22) Filed: Mar. 6, 2013

Related U.S. Application Data
(60) Provisional application No. 61/737,317, filed on Dec. 14, 2012.
(60) Provisional application No. 61/731,787, filed on Nov. 30, 2012.

(51) Int. Cl. G06F 3/0484; G06F 3/0481

(52) U.S. Cl. CPC G06F 3/0484; G06F 3/04817
USPC 715/771

(57) ABSTRACT

The embodiments of the present invention provide systems and methods which update petroleum activity data and allows for geospatial modeling of the data in an interactive fashion or for the creation of a report to display customizable reports in accordance with user-preferred fields. Embodiments of the present invention also provide methods for collection of data from various Internet resources, including Federal Energy Regulatory Commission, and specifically allow user-friendly interaction to select various fields, such as bids, contract information, well production, and produce graphical representation or generate reports that accounts for the organization of the data.

This application claims priority from U.S. Provisional Patent Application Nos. 61/731,787, filed Nov. 30, 2012, and 61/737,317, filed Dec. 14, 2012, both titled “Geographic Layout of Petroleum Drilling Data and Methods for Processing Data” which are hereby incorporated by reference.

### TECHNICAL FIELD OF THE INVENTION

The present invention relates to methods and processes of generating user-friendly geographic layouts and reports that collects petroleum drilling and production data, filters the data, provides user-specific analysis of the data, and displays and summarizes the data in a report or geospatial map through a web-based service, or the like.

### BACKGROUND OF THE INVENTION

Information relating to petroleum supply, processing of petroleum, production of petroleum, permits, licenses, and petroleum collection is offered on various governmental websites and independent sources. Drilling data of crude oil or natural gas drilling activity can be found on websites offered by U.S. Energy Information Administration (www.eia.gov) and FERC. Collecting proper data on production and collection of various crude oil and natural gas volumes is often a difficult task; the data is often not organized in a manner that allows users to view various data efficiently. The data may be organized by region (e.g., country, state, county, etc.), type of activity (e.g., drilling for oil or gas, geothermal, etc.), location (e.g., land or offshore), or well type (e.g. development, exploration, or infill), but to view the overall collection process or to appreciate how the data may impact a particular client is often lost in all the data. Clients often need to evaluate the production of petroleum and other petroleum data based on their own criteria, whether to understand the current situation or to analyze for future collection or forecasting models. These clients range from drilling companies, investment analysts, to various governmental organizations and agencies associated with petroleum analysis, including the EPA.

The proliferation of web-based systems allow for the geographic display of maps, such as Google Maps, Bing Maps, Yahoo Map, and Mapquest.com, but the application of these maps are limited in the petroleum industry. These services provide user friendly interactive methods to visualize the location and distances of various businesses, residential addresses, and various directional, traffic, and road conditions. To use one example, Google Maps uses geospatial data to collect information of various featured locations and provides information related to its location in a database format, such as a KML (Keyhole Markup Language) file format. By using this data with overlay instructions, KML files can be used to incorporate client-based information to provide client-based map-like visual information to its users. KML uses a tag-based structure with nested elements and attributes and is based on the XML standard. The use of KML files for these purposes are well known in the industry.

Both the oil and gas industries require recordation of a vast amount of data which is difficult to geographically represent and document. Currently, the industry uses rudimentary methods to view analytical data, including the manual formation of tables and charts to target oil and gas production and collection data. Other methods of data collection may include the creation of databases or output files that show only estimated values of production levels or collection levels. The current state of the prior art shows no ability to create user-specific filters to organize the vast amount of information and to visually display user-specific activity of petroleum collection data, and such.

There are currently many disadvantages to traditional methods of collecting and analyzing petroleum data. For one thing, it is extremely time-consuming for a client to scour all the various public information to obtain the necessary information that they need. Although each client seeks different information from the vast amount of data, each client often needs the same information on a daily or weekly basis depending on its line of business. Furthermore, it is often difficult to visualize any of the production levels or petroleum data by viewing tables of data that are offered by the numerous websites.

Technological advances allow clients to use various mapping capabilities on websites to view various governmental and client specific information. The usage of KML files has recently led to a number of advancements in Internet-based map technology and overlay capabilities, including the ability to use KML files to specify locations, images, polygons, 3D models for display in Google Maps, or any other geospatial software implementing the KML encoding. Any desired location has a longitude and latitude. By implementing the use of generated input files, a programmer has the ability to overlay images and data that is user specific onto the Google Maps in accordance with its associated longitude and latitude. Although the use of KML files are well known, the use of KML files in the petroleum industry is only emerging. U.S. Pat. No. 8,204,692 to Arango et al., which has a patent date of Jun. 19, 2012 discloses a “System, Program Product, and Method for Drilling Rig Activity Accounting Visualization.” The invention disclosed by Arango et al. discloses embodiments directed to the management of drilling rig activity data. Arango et al discloses a system wherein the collection of rig activity is based on numerous sources including independent inputs and commercial sources, which are communicated with its network. The network than provides the collection of rig data to a variety of users through a selected number of delivery methods, which includes charts and overlayed maps. The system disclosed by Arango et al. falls short of being able to provide a full picture of petroleum data. The publicly available petroleum data is vast, which includes a large number of fields outside rig data. Furthermore, Arango et al fails to provide a versatile user specific capability to generate customizable reports and geospatial maps in accordance with those customer preferences.

There is currently no system that allows for the versatile customization of individual reports and the ability to visualize petroleum data, such as petroleum based bids, contact information for the various operators, petroleum quality, petroleum tax or tariff information, production, collection, leasing, permits, and pipeline layout information for each of the clients. What is needed in the industry is an ability to collect the data, organize the data, customize the data in accordance with each client, and provide valuable reports or geospatial maps to view customizable information. What is further needed is a system that provides customizable data with overlays that can provide individual petroleum data of selected wells, including the ability to provide historic, fixed calendar intervals, production volume, or projection levels of selected wells. There is recognized a need to allow for the graphical layout of various petroleum related data that is customized to an interactive user over a web-based service.

### SUMMARY OF THE INVENTION

The embodiments of the present invention provide systems and methods which produce customizable reports of petroleum activity data and graphically display and update petroleum activity data. It further provides the ability to geospatially model the data, which includes physical layouts of pipelines and well location in an interactive web-based service. Embodiments of the present invention also provide methods to make each client access to the information customizable so that various petroleum-related data can be collected continuously wherein the collection of customizable fields of petroleum data is automatically updated by a server and software capable of manipulating its data.

Further embodiments of the present invention include business methodologies to implement the collection of petroleum-related activity data, including operator information, exact location of wells, production levels at each well, the layout of pipes, the associated bids, the permits and leases associated with each well, the quality of the petroleum, and the governmental taxes and tariffs or regulatory seismic information and to filter the information according to client specific needs.

Further embodiments of the invention disclose a server system that collects the various information and stores customizable fields based on user needs for the generation of interactive layouts that provide geospatial displays of petroleum related data that is capable of communicating the information through a network system. The geospatial displays may employ indicia of a petroleum production and collection location icons in an overlay fashion over portions of digitally manipulative maps. A user interface in communication with the processor of the server provides capabilities to view selected petroleum related data over the communication network. The total collection and display of the information can be performed using a web-based service, which may or may not include the use of a browser.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 is a schematic block diagram of a system according to an embodiment of the present invention;

FIG. 2 is a flow chart in accordance with embodiments of the present invention;

FIG. 3 shows a preferred embodiment of the present invention showing a Report Builder page;

FIG. 4 shows a preferred embodiment of the present invention showing a Report generated by the Report Builder page;

FIG. 5 shows a generated map in accordance with the preferred embodiments of the present invention;

FIG. 6 shows a generated map showing the location of interest in accordance with the preferred embodiments of the present invention;

FIG. 7 shows a generated map with overlays showing individual well information in accordance with embodiments of the present invention;

FIG. 9 shows a selected area in accordance with another embodiment of the current invention; and

FIG. 10 shows layover maps in accordance with another embodiment of the current invention.

### DETAILED DESCRIPTION OF PREFERRED EMBODIMENTS

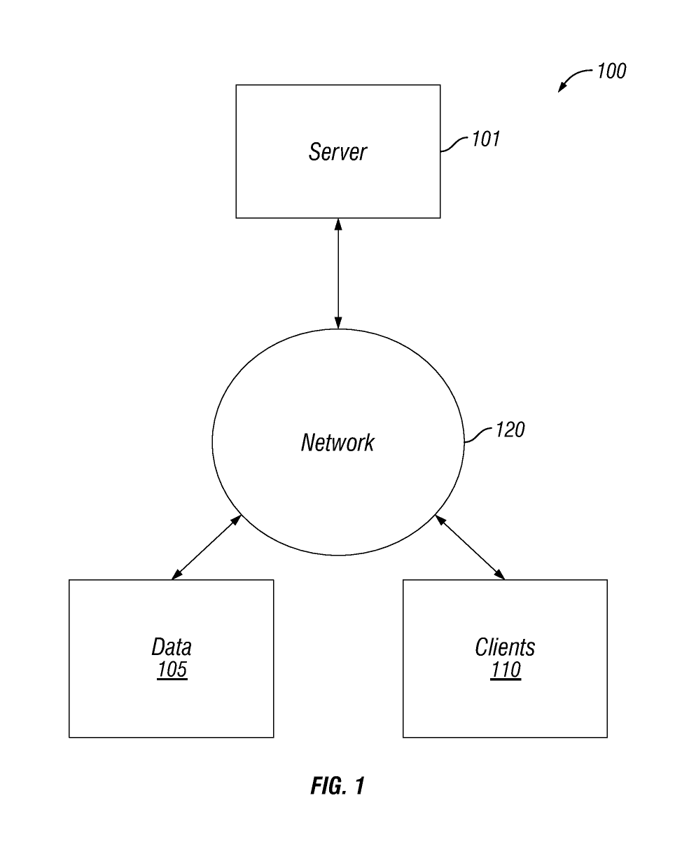

FIG. 1 is a general schematic block diagram in accordance with the embodiments of the present invention. The system 100 includes one or more clients 110 that are in communication with server 101 via one or more networks 120. Although multiple clients 110 and a single server 101 are illustrated in FIG. 1, there can be more servers and more or fewer clients. For instance, some of the functions performed by the server 101 can be performed by one or more other servers such that the server 101 can represent several devices, such as a network of computer processors and/or servers. Additionally, in some implementations, the server 101 can perform a function of a client. The client 110 is representative of an end user that can implement many different types of devices, such as a personal computer, a wireless telephone, a personal digital assistant, a smart phone, a lap top computer, a tablet, or another type of computation or communication device, a thread or process running on one these devices, and/or an object executable by one of these devices.

The system 100 also includes a data source 105. Data source 105 is connected with the server 101 via network 120. In the system 100, the server 120 can collect and/or receive data from one or more data sources and manipulate the data to generate a response to a search query received from one or more clients 110. Various methods exist to collect valuable drilling and petroleum data. For example, meta-search engines use Web Scraping, which involves the process of querying a source, retrieving the results page and parsing the page to obtain the necessary data. The meta-search engine is hosted by the server 101 and there exists a variety of ways to organize and manipulate the search for information. For example, in U.S. patent application Ser. No. 10/198,245 entitled “Method and Apparatus for Improved Internet Searching,” discloses methods to utilize multiple search engines that collect data from various websites in a manner that can efficiently organize and disperse the data, and is hereby incorporated by reference.

Various websites provide data necessary for the embodiments of the current invention. Data regarding the drilling and plugging activities, blowouts, well control problems, drilling completions, drilling permits (oil and gas), gas storage statistics, natural gas tariffs and rate schedules, required permits, monthly summary of natural gas or propane/compressed gas production, offshore water production, active pipelines, active pipeline operators, and pipeline safety violations, and various well data can be scraped from http://www.rrc.state.tx.us/data/index.php. The same type of drilling data can be collected from petroleum production data that is supplied by U.S. Energy Information Administration (www.eia.gov) and FERC associated websites. A number of state dependent websites and federal websites provide information regarding petroleum production, drilling, and activity and are hereby incorporated by reference. Although these websites often provide the data, the embodiments of the current invention organizes the data and filters the data in accordance with customizable user preferences. The result of the filtering process allows the system to present selected data in either a customizable report or geospatial map.

A variety of other remote data sources can “push” petroleum data and related activity data into server 101. This includes customer specific information, including the name of the client, contact information of the client, and personalized client activity information, or data. Other data may include field operations data that are directly inputted into the server. Other data may be provided by commercial sources, such as vendors that collect specific information regarding petroleum collection, drilling and activity, and licenses, permits, or seismic data. This data can be uploaded from a remote location via any methods well-known in the art. Once it is uploaded, it is pushed into server 101, the server organizes the data in well-known methods where the information can be extracted, or “pulled” for the formation of customizable reports or geospatial maps. In the preferred embodiments of the current invention, the data is presented to the client through the use of a web browser, such as Internet Explorer, Mozilla Firefox or Apple Safari. The use of a web browser can allow clients access with security login information, which can allow users to specify desired fields in accordance with the user needs.

Extensive data that is collected regarding the petroleum data can be organized by a variety of methods, including the organization by types of crude oil, natural gas volumes, by location, and by production levels, to name a few. For example, the server 101 can organize the vast amount of data by region (e.g., country, state, county, etc.), type of activity (e.g., drilling for oil or gas, geothermal, etc.), location (e.g., land or offshore), and well type (e.g. development, exploration, or infill). The following list shows a partial list representing the Petroleum-Related Data:

| | |
|---|---|
| API Well | A unique, numeric identifier assigned to each well drilled for oil and gas in the |
| Number | United States. |
| Additional API | Some states add additional digits to the api for wells that are redrilled or |
| | abandoned and reworked. |
| Other | Used for different numbers states use to identify the wells. |
| Identifier | |
| Well Name | The name given to the well. |
| Mineral Lease | An agreement between a property owner and another party who is allowed to |
| | explore for and extract minerals that are found on the property for a stated time. |
| XID | Internal cross reference ID. |
| State | The state where the well is located. |
| County | The county where the well is located. |
| District | The district where the well is located. |
| Field Name | The field name where the well is located. |
| Lat | The latitude coordinate of where the well is located. |
| Long | The longitude coordinate of where the well is located. |
| Operator | The name of the operator of the well. |
| Opr Num | The number of the operator. |
| Surface | The land surface owner. |
| Owner | |
| Oil Trans | Oil Transported |
| Gas Trans | Gas Transporter |
| Gravity | Specific Gravity of the liquids from the well. |
| P4 | Texas transporter report available. |
| P17 | Texas commingling report available. |
| Well Status | Whether the well is producing, abandoned, plugged, etc. |
| Well Type | The type of well it is, oil, gas, discovery, etc. |
| Horizontal | Whether or not the well is vertical or horizontal. |
| Well | |
| Cumulative | Total production of oil for a given field. |
| Oil | |
| Cumulative | Total production of gas for a given field. |
| Gas | |
| Cumulative | Total production of water for a given field. |
| Water | |
| Depth | The total depth of the well. |
| PBTD | Plug Back Total Depth of well. |
| Elevation | Elevation of the well. |
| Application | The date the well permit was submitted. |
| Date | |

This is merely a partial list that comprises the Petroleum-Related Data and it can include a large variety of other types of information provided publicly or by commercial sources or by individual input. The server 101 can organize the data in a database in accordance with any one of these fields. General storage and organization of the database by server 101 is well known in the industry and are hereby incorporated by reference. The frequency of server 101 to collect the Petroleum-Related Data is dependent on need. In accordance with the preferred embodiment of the present invention, the collection of the data occurs daily, but it can occur more frequently to update immediate needs of clients. Embodiments of the present invention also include ways to update the database data automatically.

Many different types of servers are well known in the industry. The server can be made from one or several servers or a cluster that is managed by a telecommunications provider. The capacity specifications for each server may vary, including the type of memory and processor it contains. The network 120 can also take a variety of forms. The preferred embodiment of the present invention uses a system that allows for cellular mobile and smart phone telephone systems and data packages. Any variety of telephone systems can be incorporated to communicate with network 120, which includes smart phones, PDAs, tablets, laptops, Blackberries, or other handheld devices. It includes both analog and digital voice data systems. Inputting information from computers is well known in the industry, which includes the ability for clients to push data via any well-known types of inputting means.

The incorporation of client information with the pushed data to server 101 is a critical element of the process. The Customizable Client Information may include any of the following fields: (1) client name, (2) client contact information, (3) past history of report generation and geospatial map generations, (4) listing of relevant regions, locations, wells types, production capabilities, (5) listing of relevant time periods of petroleum activity data, (6) particular specified pipelines, (7) selected permits or licenses, and other selected data. The Customizable Client Information can include any or all of the variables included with the Petroleum-Related Data as long as the selection of the fields are specific to each customer. Server 101 is capable of storing each of the client preferences in a Client Profile and is capable of incorporating the Customizable Client Information in filtering out all the data that server 101 collects. It also allows for the creation of a secured account for each client to save the client preferences. The technology to create individual, secured accounts with stored client information is well known in the industry and is hereby incorporated by reference.

Client Profile can also account for client's frequent uses and past uses of various selected variables. Before server 101 provides the client with a generated report or geospatial map, server 101 can combine the needs of the Client Profile with client profile information, the system allows or the generation of user specific information geo-spacial maps and reports using geospatial data. The Petroleum-Related Data is used with customized client preferences to filter out unneeded data before the filtered information is displayed to the user. The Client Profile can also provide methods to monitor petroleum production and collection activity and other petroleum related data automatically.

The use of geospatial data is well known in the industry, which allows for Geospatial Information System (“GIS”) technology to incorporate location integration for storing, editing, analyzing, sharing, and displaying geographically-referenced information. GIS also allows users to create interactive queries or searches, analyze the spatial information, and edit the data. Any GIS technology, including the use of KML files, well known in the art can be utilized with embodiments of the present invention. For example, GIS can combine user preference information regarding client's location and user selected areas and generate relevant location lists for all well activity associated with the x, y, and z coordinates, longitude, latitude, and elevation that is collected from the data source.

Preferred embodiments of the present invention allow clients to use the type of information they select and in the format they desire to pull that data from the collected database of information. Such information can include any combination of the Petroleum-Related Data based on the Customizable Client Information.

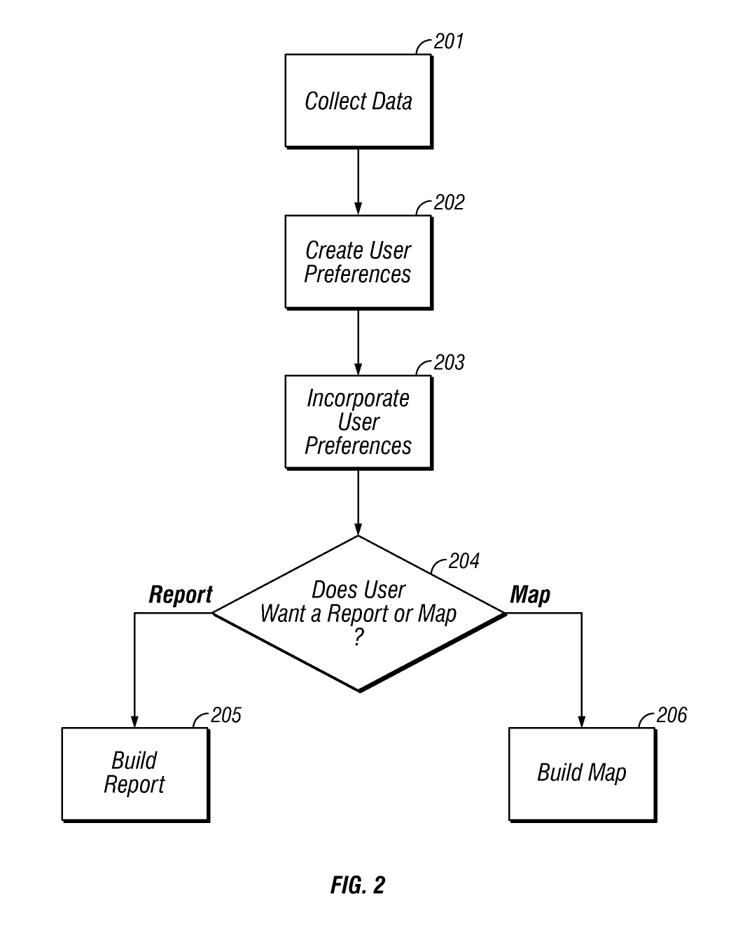

FIG. 2 is a simple flow chart representing the preferred embodiment of the current invention. Server 101 collects data from various governmental websites and commercial resources in step 201. At step 202, a client sets his preferences, including the type of information that the client is interested in. This includes the Petroleum-Related Data and locations of interest. In step 203, the server 101 incorporates the user preferences in with the available data set, which includes user selected preferences. In step 204, the application determines if the client intends to build a report or show the user selected information on a map. If it is a report, the user preferences are used to build a report in step 205. If it is a map, the application applies the information into a KML file map displaying the user preferred information in step 206.

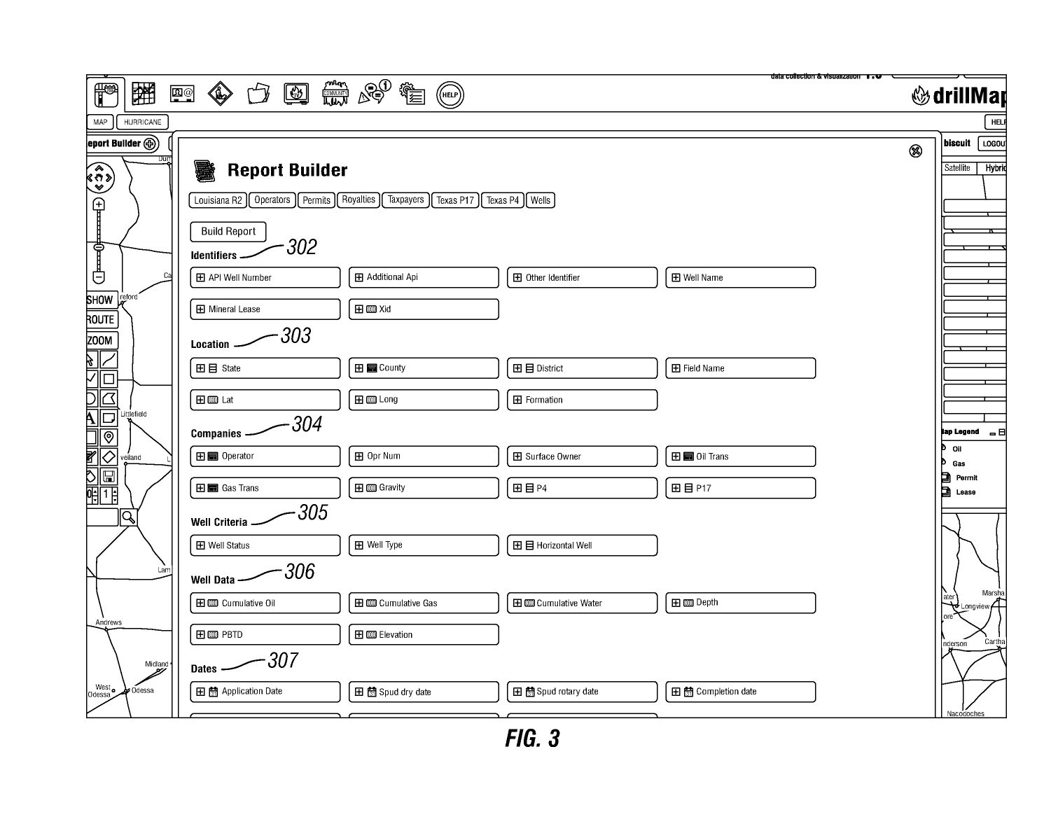

FIG. 3 shows a preferred embodiment of the present invention. In accordance with step 202, the system allows for user preferences to be inputted using a number of selected variables. FIG. 3 represents a Report Builder screen wherein the data set can be chosen to be selected. Various options can be set to build a customer preferred report. For example, if the user selects the Wells Tab, the user is given a number of Categorical Variables, such as Identifiers 302, Location 303, Companies 304, Well Criteria 305, Well Data 306, and Dates 307. The following is a list of possible location filters used in the creation of user selected information:

| | |
|---|---|
| US Counties | Displays US counties on the map. |
| Texas Abstract | Displays the Texas abstract overlay on the map. |
| Texas Surveys | Displays the major property holders of the Original Texas Land Survey |
| | on the map. |
| Kansas Landgrid | Displays the sections for Kansas on the map. |
| Oklahoma Landgrid | Displays section township range for Oklahoma on the map. |
| Louisiana Landgrid | Displays section township range for Louisiana on the map. |
| Arkansas Landgrid | Displays section township range for Arkansas on the map. |
| Montana Landgrid | Displays section township range for Montana on the map. |
| Mississippi Landgrid | Displays section township range for Mississippi on the map. |
| New Mexico Landgrid | Displays section township range for New Mexico on the map. |
| North Dakota | Displays section township range for North Dakota on the map. |
| Landgrid | |
| North Dakota Laterals | Displays the laterals, the direction and distance for a horizontal well, |
| | for North Dakota on the map. |
| Wyoming Landgrid | Displays section township range for Wyoming on the map. |
| Gulf Grid | Displays the Gulf grid on the map. |
| Texas District | Displays the Texas districts on the map. |
| Exxon Louisiana | Displays the Exxon Louisiana Pipeline on the map. |
| Pipeline | |
| Shales | Displays shales on the map. |
| Texas Natural Gas | Displays the natural gas pipelines in Texas on the map. |
| Pipelines | |
| Texas Crude Oil | Displays the crude oil pipelines in Texas on the map. |
| Pipelines | |
| Majors and Shales | Displays majors and shales on the map. |
| Crockett and Reagan | Displays pipelines with labels in Crockett and Reagan county in Texas |
| County | on the map. |
| Parcel DeWitt County | Displays the parcels for DeWitt county in Texas on the map. |
| Gulf Leases | Displays the Gulf Leases as assigned by the Bureau of Ocean Energy |
| | Management. |

Within each of these Categorical Variables, there is a list of Individual Variables. Individual Variables under Identifiers 302 include API Well Number, Well Name, and Mineral Lease. All of these Individual Variables can be set to the user preferences in building a desired report. Under the Location Categorical Variable, Individual Variables, such as State, County, District, and Field Name, as well as locations selected by Latitude and Longitude can be configured to generate the desired report. Under Companies Categorical Variable, Individual Variables such as Operator, Operator Number can be configured. Under the Categorical Variable of Well Criteria 305, the Well Status, the Well Type, and Horizontal Well variables can be set. Under Well Data 306, the variables for Cumulative Oil, Cumulative Gas, Cumulative Water, Depth, PBTD, and Elevation can be set. Under Dates 307, the variables for dates, such as Spud dry date and Completion date is listed.

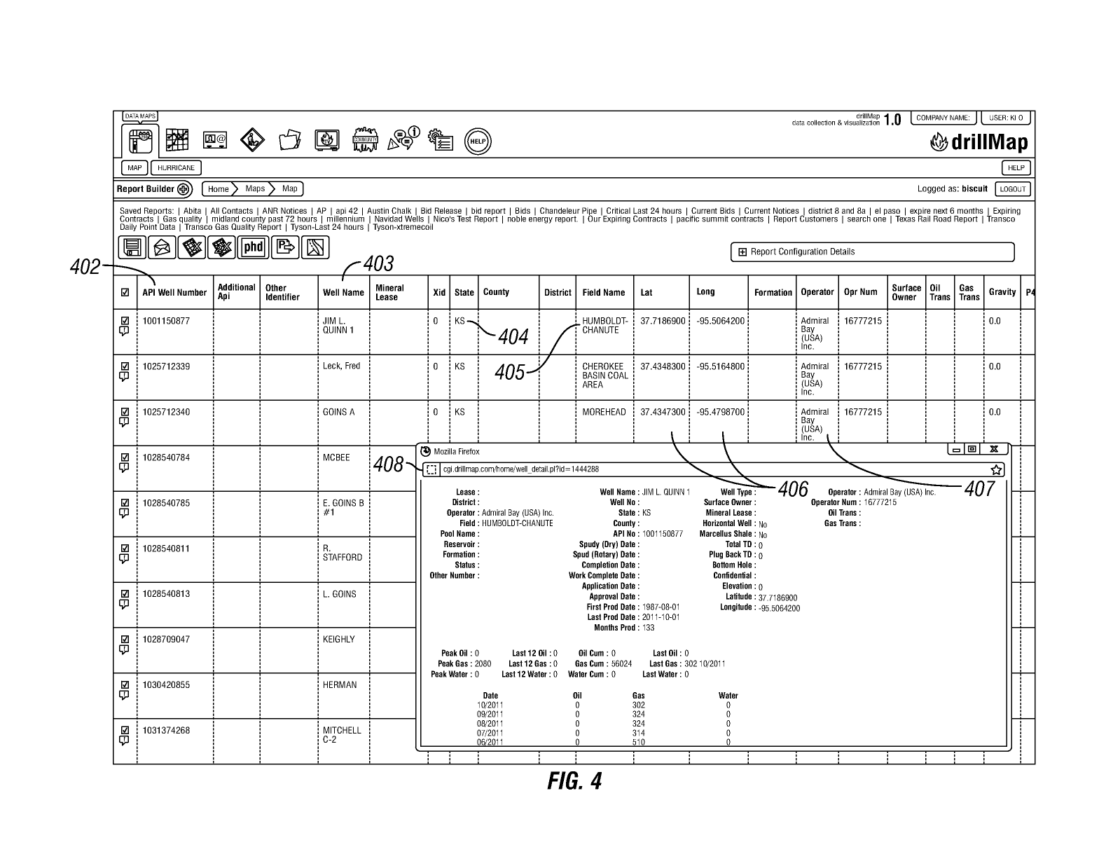

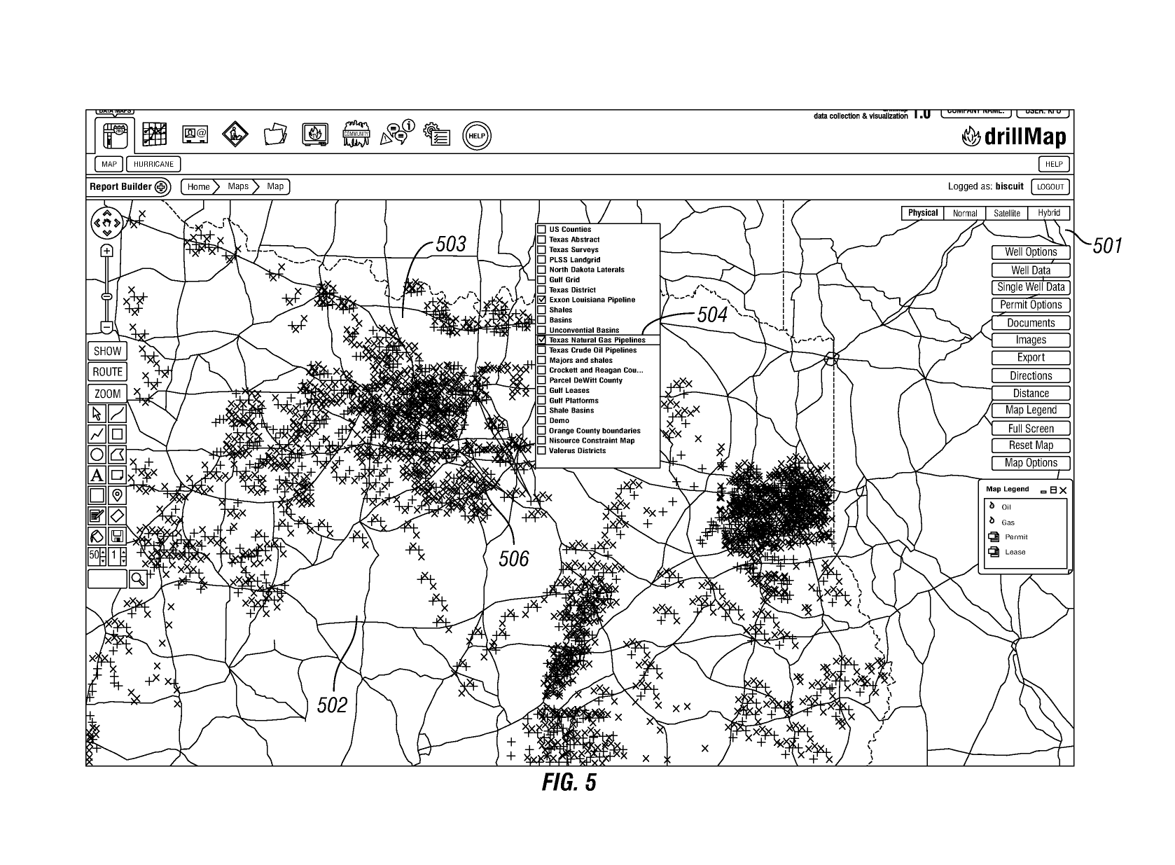

All of the Individual Variables can be selected to the user desired preferences so that a user preferred report can be generated. Once a report is generated, the user can scroll through all the individual citations arranged by individual wells as shown in FIG. 4. The report generated by FIG. 4 shows the API Well Number 402, Well Name 403, State of Well Location 404, Field Name 405, Latitude and Longitude 406, the Operator 407. Other Individual data can be sorted by Bid information, Bid Reports, Current Bids, Current Notices, Expired Contracts, Gas Quality, and various other reports, such as Texas Rail Road Reports. Each of the individual well can be de-selected. Individual well data can be viewed by selecting individual wells as shown in pop-up box 408, which shows individual data for particular API Wells. These reports can be saved, emailed, or exported to a general spreadsheet or a different application. The report can also export the information to a map function.

If the client prefers to view a map rather than a report, the client can select to build a map as shown in FIG. 5. The generated map 501 can be zoomed in or zoomed out depending on the preferred viewing range of the client. Once the map is properly sized, the user can select multiple layers for viewing various selected user preferences. FIG. 5 shows a zoomed in area 502 of Texas and Louisiana with the overlays of Exxon Louisiana Pipeline 503 and Texas Natural Gas Pipelines 504 selected. The overlay selections can also comprise district information, county information, surveys, basins, shales, lease information, and platforms to name a few. The maps also display specific pipelines 506 that actually show the start and end of various pipelines, which is privately held information that is added to the server 101. As many and as few of the selected overlays can be incorporated for viewing by the client.

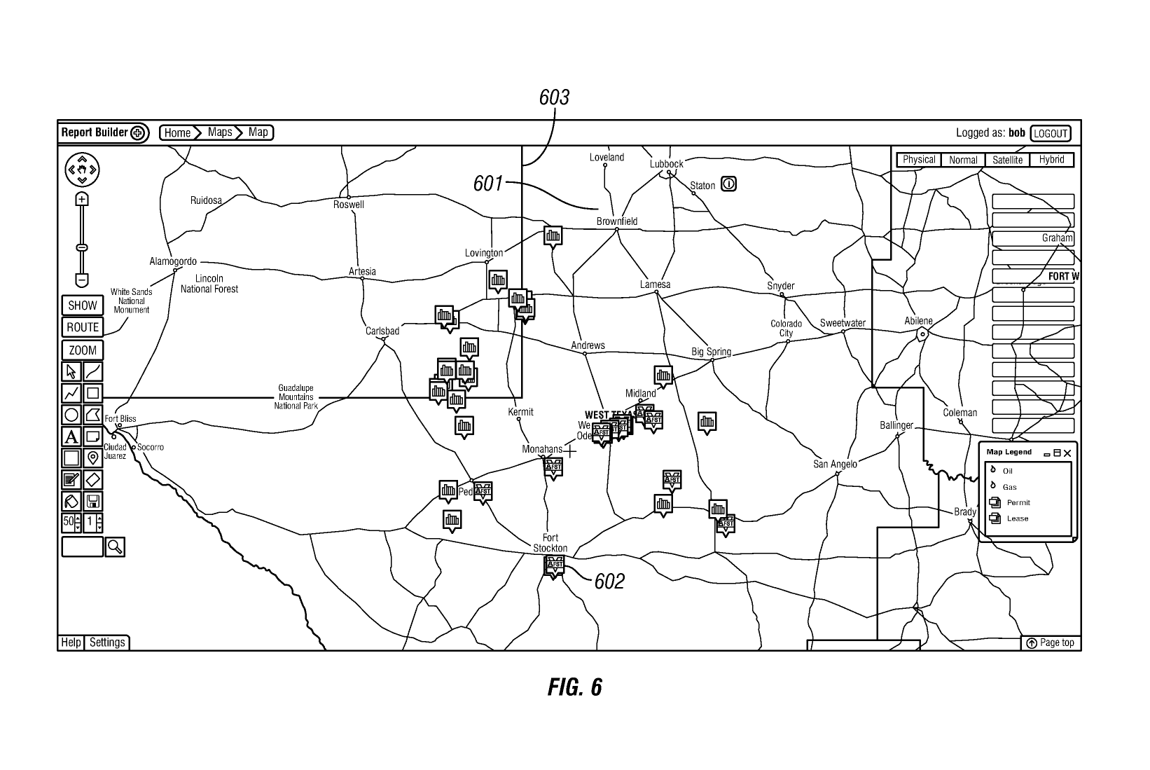

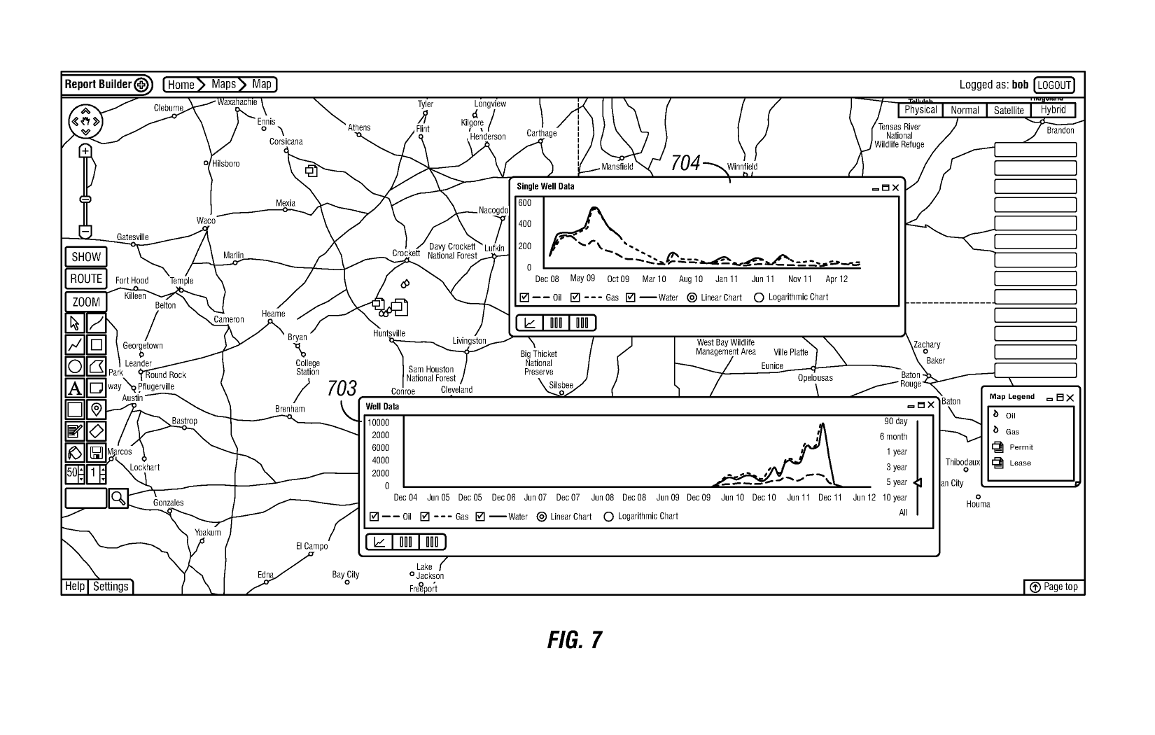

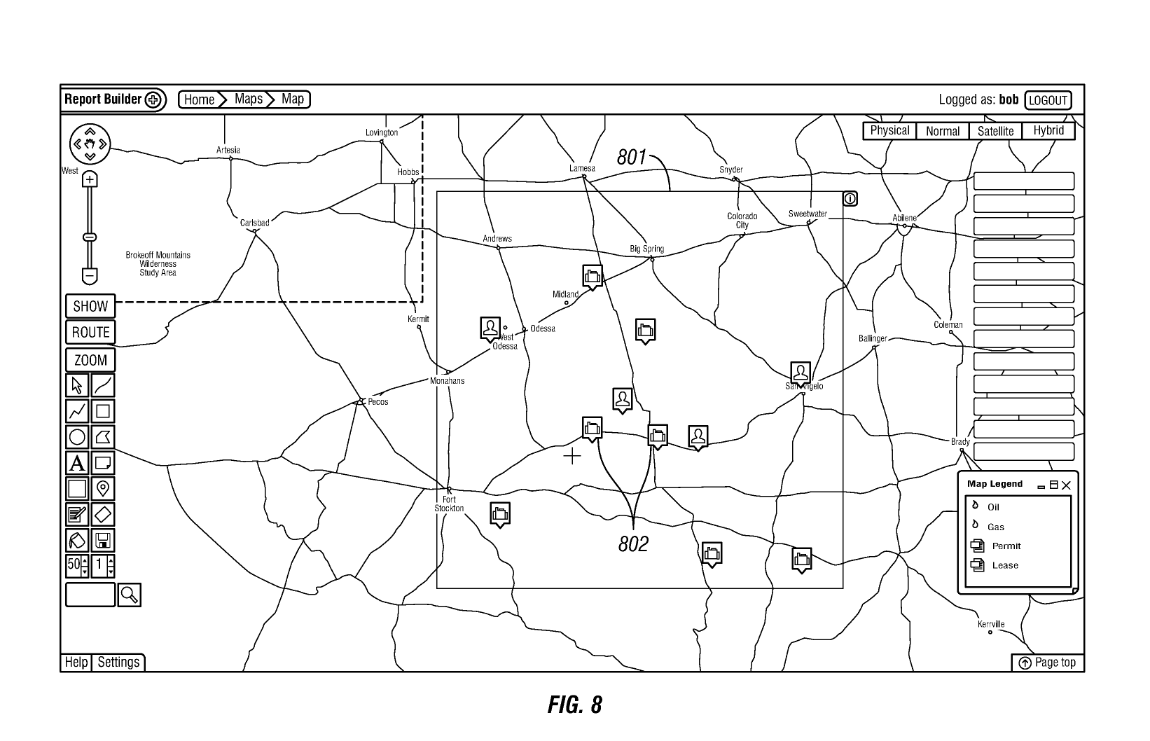

FIG. 6 shows a map generated with user preferences in accordance with a preferred embodiment of the invention. The area of the map can be zoomed in and zoomed out in accordance with the desired area of interest 601. The user can select all the wells of a particular state (if desired). Once a particular area or state is selected, the client has the ability to choose various individual variables, such as Wells data, Permits, Rigs, Leases, Documents associated with the Well, Oil Prices, Gas Prices, and information related to any of the sales. These individual variables that are selected by the client can all be viewed in overlays. The user can select a box on the map to indicate the area to show all the relevant, chosen data. FIG. 6 shows well data for icons for all the wells in West Texas area that was selected by the user. Each of the icons listed over the map, such an icon Fort Stockton 602 allows for the user to select that icon. These icons can be selected to view individual well data for that particular icon. Smaller boxes of activity can be enlarged, such as box 603, or the boxes can be minimized with standard use of map enlargement and decreases known in the industry. Additional well data can be viewed by pop-up windows by selecting individual well data as shown in FIG. 7. FIG. 7 shows well single well data for a desired well showing activity from December 2008 to April 2012. The time frames for individual well data can be changed for each individual well data viewing. Well data 703 shows that the individual can alter the date range from 90 days to 10 years, or all available data. The popup boxes that are overlayed can be moved by conventional user-friendly input means, such as a computer mouse. The charts that are available can be viewed in linear charts or logarithmic charts depending on the client user preferences. The history of each of the well data can be saved as with any history of user preferences in the report builder or the map builder functions. The saved history is unique to each client, and the server retains all client information by creating profiles of each client. Thus, the client's user preferences can always be restored when logged into the server website.

As discussed above, a number of variables can exist for viewing of the various overlays in the map, such as permit data 704. In another embodiment of the preferred invention, route information can be provided to client specific areas of interest. As shown in FIG. 8, a client can draw a box 801 around an area of interest. Well data 802 will be displayed with the boxed area. By selecting the desired well of a starting point and a well of an ending point, the map can generate a direction, mileage information, and travel time from the two locations that are selected by the client. If any location information is tagged on the map, the map feature can direct the user between any point of the well and the tagged location. The maps themselves can be exported to a conventional spreadsheet application or save the data.

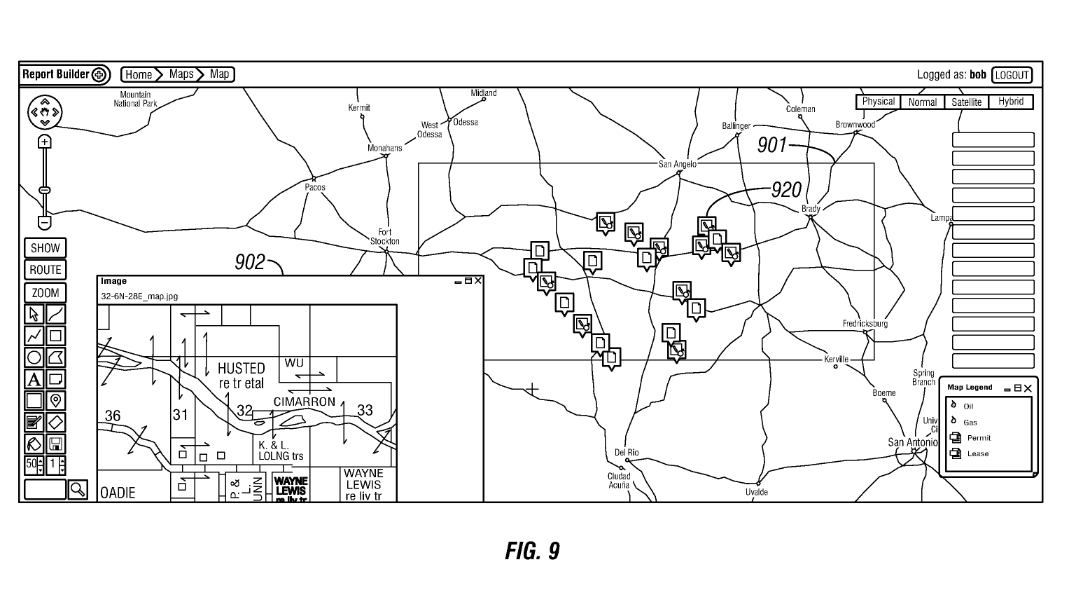

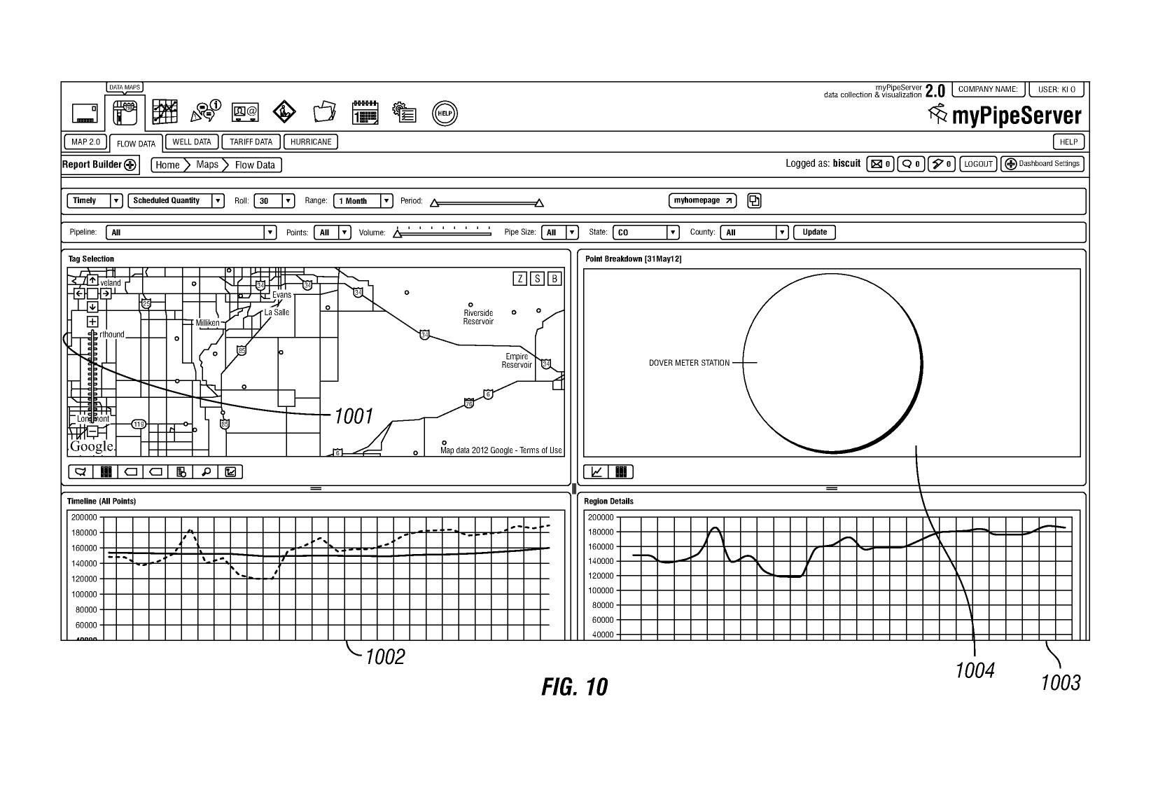

FIG. 9 shows another embodiment of the present invention. FIG. 9 shows a boxed in area San Angelo. The area within the box 901 contains all the collected icons 920. Box 902 is an enlarged area of the more specific description and layout of pipelines, and such. FIG. 10 shows another embodiment of the present invention. FIG. 10 shows multiple layover showing the different type of information that can be presented. It includes map 1001, timeline layover 1002, a regional detail layover 1003, and a point breakdown layover 1004.

Various types of overlays can exist based on user-specified fields, which includes well specific information associated with selected wells. The operations can include graphically displaying a time-sequenced evolution of a petroleum production and collection activity for a preselected period of time defining a time-sequenced evolution of transaction history. The report generation can be displayed in a number of different methods, including the use of bar graphs, line graphs, generation of tables, and map displays. Furthermore, the selection of well specific information can also display forecasting information of well data based on past historical performances of the selected well. Various forecasting models exist for the determination of production amounts. For example, EP Patent titled “Forecasting petroleum reservoir production using genetic algorithms” (WO2008036664A2) describes one forecasting algorithm using genetic algorithms tied to reservoir locations and reservoir models. Many different types of forecasting algorithms exist and are hereby incorporated by reference.

Pipeline information can also be viewed in overlays of the map. Although the data associated with petroleum-related activity can be collected in a report, the showing of actual pipeline locations provide insight to users of exact locations of the pipelines in relation to other tagged items in the map. Other features also exist in accordance with the preferred embodiment of the present invention. The distance between any two points can be viewed by tagging various locations on the map. Other capabilities to include user specified information, such as notational texts associated with a given area, can provide the client with individualized comments for each well. Each selected well, or an item, such as a license or permit, can also be selected so that such customization can be highlighted and saved for each customer need.

It should be appreciated by those skilled in the art that the conception and specific embodiments disclosed herein may be readily utilized as a basis for modifying or designing other structures for carrying out the same purposes of the present invention. It should also be realized by those skilled in the art that such equivalent constructions do not depart from the spirit and scope of the invention as set forth in the appended claims.

We claim as follows:

1. A system to create a geospatial display of petroleum well data and user-specified information comprising:
a server capable of collecting data from websites and from user input of petroleum-related data, the Petroleum-Related Data comprising at least one of the following variables:
API Well Number, Well Identifiers of any kind, Well Name, Mineral Lease information, State Location of Well, County Location of Well, District Location of Well, Field Name, Latitude of Well Location, Longitude of Well Location, Operator, Operator Number, Surface Owner, Oil Transported Information, Gas Transported Information, Specific Gravity, Well Status, Well Type, Horizontal Well Information, Cumulative Oil Production, Cumulative Gas Production, Cumulative Water, Depth of Well, Plug Back Total Depth of Well, Elevation of Well, and Permit Application;
the server having memory and a processor capable of organizing the petroleum-related data;
input means for inputting Customizable Client Information, the Customizable Client Information comprising at least one of the following variables in the Petroleum-Related Data as Preferred Client Data and further including one of the following fields: Customer's area of location interest, Customer past uses, Customer preferred list of Wells, Customer preferred list of Operators;
said server being able to use the Customizable Client Information to filter the Petroleum-Related Data so that it can generate a map showing only the selected customizable client information of the petroleum-related data.

2. The system according to claim 1 wherein the Customer's area of location is created by user input of a box that is selected over an area of interest on the map.

3. The system according to claim 2 wherein the Customer's area of location that is selected shows icons of each well within its area in accordance with Customizable Client Information.

4. The system according to claim 2 wherein the Customer's area of location that is selected shows icons of each well within its area in accordance with Customizable Client Information.

5. The system according to claim 1 wherein the selected Customer's area of location displays petroleum related pipelines in accordance with Customizable Client Information.

6. The system according to claim 3 wherein a specific well icon can be selected from the Customer's area of location that will display individual information associated with the well of the well icon.

7. The system according to claim 6 wherein individual information of the well is well production information, and the production information is displayed in an overlay graph showing the well production in accordance with a selected amount of time.

8. A system in accordance with claim 1 wherein the system allows for the overlays of forecasting overlays of individual specified wells.

9. A system to build a report of petroleum well data and user-specified information comprising:
a server capable of collecting data from websites and from user input of Petroleum-Related Data, the Petroleum-Related Data comprising at least one of the following variables:
API Well Number, Well Identifiers of any kind, Well Name, Mineral Lease information, State Location of Well, County Location of Well, District Location of Well, Field Name, Latitude of Well Location, Longitude of Well Location, Operator, Operator Number, Surface Owner, Oil Transported Information, Gas Transported Information, Specific Gravity, Well Status, Well Type, Horizontal Well Information, Cumulative Oil Production, Cumulative Gas Production, Cumulative Water, Depth of Well, Plug Back Total Depth of Well, Elevation of Well, and Permit Application;
the server having memory and a processor capable of organizing the petroleum-related data;
input means for inputting Customizable Client Information, the Customizable Client Information comprising at least one of the following variables in the Petroleum-Related Data as Preferred Client Data and further including one of the following fields: Customer's area of location interest, Customer past uses, Customer preferred list of Wells, Customer preferred list of Operators;
said server being able to use the Customizable Client Information to filter the Petroleum-Related Data so that it can generate a report showing only the selected customizable client information of the petroleum-related data.

10. A system in accordance with claim 8 further including the ability to export the report into a spreadsheet.

11. A system in accordance with claim 8 further including the ability to individual select wells for the generation of user-specified report.

12. Method of collecting petroleum related data and creating a report showing customizable data including:
collecting Petroleum-Related Data from publicly available websites and input from users, the Petroleum-Related Data including at least one of the following variables:
API Well Number, Well Identifiers of any kind, Well Name, Mineral Lease information, State Location of Well, County Location of Well, District Location of Well, Field Name, Latitude of Well Location, Longitude of Well Location, Operator, Operator Number, Surface Owner, Oil Transported Information, Gas Transported Information, Specific Gravity, Well Status, Well Type, Horizontal Well Information, Cumulative Oil Production, Cumulative Gas Production, Cumulative Water, Depth of Well, Plug Back Total Depth of Well, Elevation of Well, and Permit Application;
organizing the Petroleum-Related Data, and
collecting user-specified fields for filtering the Petroleum-Related Data to display only the user-specified fields.

13. The method according to claim 12 wherein the collected user-specified fields is used to generate a report.

14. The method of claim 12 wherein the report is capable of being exported into a spreadsheet.

15. The method of claim 12 wherein the collected user-specified fields is sued to generate a map.

16. The method of claim 15 wherein the map can display icons of wells associated with a user-selected box of an area of interest.

17. The method of claim 16 wherein an icon of the icons of wells can be selected to display individual information of the selected well.

18. The method of claim 17 wherein the individual information of the selected well includes well production information.

19. The method of claim 18 wherein the well production information is shown graphically in an overlay graph.

20. The method of claim 18 wherein the well production information is shown graphically in an overlay graph that shows a timeline of production in accordance with user selected time frames.

21. The method of claim 18 wherein the well production information is shown graphically in an overlay graph that shows forecasting of production values.
